(19) United States
(12) Patent Application Publication
(10) Pub. No.: US 2008/0250962 A1
(43) Pub. Date: Oct. 16, 2008

(54) METHOD FOR ADJUSTING PRINTING PRESS MODULES

(76) Inventors: Holger Schnabel, Rottendrof (DE); Stephan Schultze, Lohr am Main (DE)

Correspondence Address: Striker, Striker & Stenby, 103 East Neck Road, Huntington, NY, 11743, US

(21) Appl. No.: 12/100,038

(22) Filed: Apr. 9, 2008

(30) Foreign Application Priority Data
Apr. 10, 2007 (DE) 10 2007 017 096.5
May 24, 2007 (DE) 10 2007 024 323.7

(51) Int. Cl. B41L 3/08

(52) U.S. Cl. 101/486

(57) ABSTRACT

The present invention relates to a method for dynamically adjusting at least one printing press module of a printing press (100), in order to correct a first register. Only the first register is changed. Further registers are decoupled from this dynamic adjustment by coupling correction values (146, 148, 150) for further printing press modules with consideration for dynamic time elements (140, 142, 144).

The present invention relates to a method for adjusting printing press modules, a printing press, a computer program, and a computer program product.

### RELATED ART

In the field of material web-processing machines, e.g., printing presses, and, in particular, gravure presses, it is provided that colors are printed directly one over the other in order to obtain a good printing result. If register deviations occur in a longitudinal register or color register, an affected printing unit is adjusted using a register controller. When a printing unit is adjusted, the web—which forms a frictional unit together with the non-driven pressure roller and the driven impression cylinder—is also displaced. The web tension and the register therefore change upstream of every printing unit that had the register deviation that was adjusted. The register controllers downstream of the adjusted printing unit with the register deviation must therefore also be acted upon in order to correct a dynamic register error.

In this context, publication DE 10 2005 019 566 A1 describes a drive system for a printing press with several individually-drivable printing units that are equipped with longitudinal register adjustment devices. A register deviation is responded to with an adjustment of the related printing unit. Since the registers upstream and downstream of the printing unit change at the instant when the adjustment is made, the associated register controllers must also be active. With this drive system, a static, coupled adjustment strategy of the printing units or drawing rollers is realized for register correction. An upstream coupling strategy and a downstream coupling strategy must be carried out separately. The registers of the downstream printing units are therefore changed when the web tension difference is conveyed further. The register controllers must therefore correct the dynamic register errors that occur.

### ADVANTAGES OF THE INVENTION

The present invention relates to a method for dynamically adjusting at least one printing press module of a printing press for correcting a first register. Only the first register is changed. Further registers are decoupled from this dynamic adjustment by coupling correction values for further printing press modules with consideration for dynamic time elements.

In the embodiment, printing press modules may be adjusted with different amplitudes and/or a different dynamic response.

In an upstream control strategy, all other registers are decoupled from the register to be (adjusted. As an alternative, or in addition thereto, a downstream control strategy may also be carried out, in which case registers that are downstream of the first register are decoupled (registers upstream of the register to be adjusted are decoupled per se).

The correction values, e.g., values for an angle correction, may be provided with consideration for a correction value of the at least one first printing press module.

In a further embodiment, the dynamic time elements are adjusted, and/or several time elements are combined with each other, it also being possible to take into account proportional, differential, and/or integral dynamic time elements of the printing press modules. In one variant, it is possible to take a dynamic response of the dynamic time elements into account.

The inventive printing press is designed to dynamically adjust at least one printing press module, in order to correct a first register. The printing press only changes this first register. The printing press decouples further registers by coupling correction values for further printing press modules with consideration for dynamic time elements.

In the embodiment, the at least one printing press module of the printing press is designed as a printing unit. The printing press is designed to carry out at least one step, and usually all steps, of the inventive method.

The present invention also relates to a computer program with program code means for implementing all steps of an inventive method when the computer program is run on a computer or a related arithmetic unit, in particular in an inventive printing press.

The computer program product—which is provided according to the present invention—with program code means, which are stored on a computer-readable data storage device, is suitable for carrying out all steps of a method when the computer program is run on a computer or a related arithmetic unit, in particular on a printing press.

With the present invention, it is possible, e.g., to decouple the adjustment motion of a printing unit, so that the register change acts only on the first register, which was affected, and all other registers considered in the control are decoupled from this adjustment. As such, their register controllers do not need to be activated.

In one variant of the inventive method, the dynamic time elements to be taken into account are monitored, and they are therefore regulated or controlled. Within the framework of the dynamic adjustment of the at least one printing press module for correcting the first register, this may mean that constants, factors, or amplitudes of the time elements that typically have a different dynamic response are monitored and, e.g., adjusted.

In one embodiment, with a downstream flow, the printing unit is adjusted when a register deviation occurs. All downstream printing units and/or drawing rollers may be adjusted dynamically with consideration for different time elements, e.g., proportional elements P, PT1, PT2, PTn, differential elements DT1, DTn, Tt, or integral elements It1, Itn, for the printing press modules.

With an upstream flow, the printing unit at which the register deviation occurs is not adjusted. Upstream printing units and/or a draw-in mechanism are adjusted simultaneously using control commands, e.g., using inverse control commands, which are generally provided with a factor or which may be selected dynamically. The downstream printing units and/or drawing rollers are adjusted with identical or different decoupling. This may be carried out, e.g., with a different amplitude and/or different dynamic response of the dynamic time elements, e.g., P, PT1, PT2, PTn as proportional time elements, DT1, DTn as differential time elements, and with Tt, IT1, ITn as integral time elements. Different decoupling elements may be combined.

With the present invention it is also possible to completely decouple an adjusting motion when a register deviation occurs, for a color/precursor color control, and for key color control.

In the case of a coupled, dynamic adjustment of the printing press modules, which are designed as impression cylinders, in order to optimize the register correction, it is provided that the register adjustment is decoupled by coupling correction values to several printing press modules, which are designed as printing units and/or drawing rollers.

Adjustment motions may therefore be completely decoupled from printing press modules in order to perform register correction. In one embodiment, this means that only the related register y(i−1, i) changes. All other registers considered in the control remain unaffected by this adjustment. In the present description, a register error y (i, j) means that the register error between printing units i and j is being considered.

In this manner, it is also possible to completely decouple the adjustment motion, when a static coupling is involved. In one embodiment, the present invention makes possible different dynamic control strategies and, therefore, different decoupling strategies in combination, e.g., between color/precursor color control and/or key color control. This also results in a combination of dynamic and static couplings based on the behavior of the printing press or material, and in an expansion of the color/precursor color control to include any possible colors.

The adjustment motions for register correction may therefore be completely decoupled. Nor is it necessary for the register controller to correct the subsequent registers. This results in a linearization of the printing process and less waste.

The present invention may be used, e.g., to perform coupled, dynamic impression cylinder adjustments to perform register correction in a printing press, in particular a gravure press or an in-line flexo printing press, to account for web tension and to perform register control.

One possible application of the present invention is in the printing and processing of paper or textile webs, and material webs in general, in which case processing registers, e.g., color registers as the registers to be controlled, may be controlled, so that an optimized control and decoupling of the processing registers is possible.

In a first control strategy with consideration for the color/precursor color, the adjustment is carried out relative to adjacent colors, i.e., y(1, 2), y(2, 3), y(3, 4). In this regard, it is also possible to perform and/or control the register adjustment for any color combinations, e.g., also y(2, 4), y(3, 5), y(4, 7), and not just to a fixed color as the reference, e.g., y(1, 2), y(1, 3), y(1, 4), as may be provided in order to realize a key color control.

The product web for which the method may be realized may be made, in general, of paper, textile, cardboard, foil, plastic, or any other type of flat, printable material. The printing press is typically a shaftlessly driven printing press, i.e., every printing press module—which is designed as a printing unit, in particular—may be adjusted individually.

This method is also suited, e.g., for operating a web press. Therefore, at least one register control, register correction, and/or a suitable handling of an ink and an adjustment of printing press modules may be carried out. As a result, e.g., the coupling of the printing units is optimized in terms of the register error.

In one embodiment, the decoupling of the register adjustment may affect directly adjacent registers, so that each color may be adjusted relative to its precursor color, e.g., y(1, 2), y(2, 3), . . . , y(i−1, i), y(i, i+l), . . . , y(n−1, n).

The adjustment of an impression cylinder i and an associated change of the register y(i−1, i) are decoupled via the adjustment of the downstream printing units, so that all other registers, y(1, 2), . . . , y(i−2, i−1), y(i, i+1), y(i+1, i+2), etc., remain unchanged.

A register deviation at one impression cylinder i may be compensated for by adjusting a printing press module designed as a draw-in mechanism, and all upstream impression cylinders 1, . . . , (i−1), and by adjusting all downstream impression cylinders i+1, . . . , n in such a manner that only register y(i−1, i) changes and all other directly adjacent registers y(1, 2) . . . , y(i−2, i−1), y (i, i+1), y(i+1, i+2), etc., remain unchanged and are therefore decoupled from the register change.

In one possible embodiment, the register adjustment is decoupled relative to a key color, that is, all registers are adjusted relative to a previously defined color. In this context, a register deviation at one impression cylinder i may be compensated for by adjusting the draw-in mechanism and all upstream impression cylinders 1, . . . , (i−1), and/or by adjusting all downstream impression cylinders i+x1, . . . , n in such a manner that only register y(s, i) changes and all other registers y(s, 2), . . . , y(s, i−1), y(s, i+1), . . . remain unchanged relative to key color s, and are therefore decoupled from the register adjustment.

The dynamic adjustment or dynamic co-adjustment of the printing units may take place in a weighted manner. As an alternative, the dynamic co-adjustment of the related printing units may take place in an unweighted manner. In addition, the dynamic co-adjustment may take place using a combination of several dynamic time elements, preferably proportional time elements PT1, PTn, differential time elements DT1, DTn, integral time elements IT1, ITn, all-pass elements, or dead-time time elements and/or weighting elements.

In one embodiment of the present invention, the decoupling may be carried out with a combination of key color and color/precursor color. The decoupling strategy is typically changed from production to production. It is also possible to change the decoupling strategy during the printing process. In a first variant, a change may be carried out during different production phases and different productions, e.g., an acceleration phase, stationary printing processes, and production to post-production. Using dynamic and static coupling, it is possible to react to production-specific features, such as the material to be printed on, temperature, humidity, web length, distance between printing units, printing press speed, etc.

It is also possible to automatically adapt the length and/or to adjust dynamic time elements. In one embodiment of the present invention, it is therefore practical to automatically measure the lengths between printing units and to adapt the time constants of the time elements accordingly, so that the dynamic time elements are not corrupted by changes in lengths or incorrect length inputs.

This makes it possible, e.g., to automatically adapt length and, therefore, to automatically adjust the dynamic time elements. The parameters of the dynamic coupling may be adapted to the printing press speed. In addition, the parameters of the dynamic coupling may be adapted proportionally to the reciprocal of the printing press speed. It is also possible to adapt the parameters of the dynamic coupling to the web length. The parameters of the dynamic coupling may be adapted, in particular, to the web length and/or width in a proportional manner. The parameters of the coupling may also be adapted to the type of material to be printed on.

Additional clamping points may be incorporated in the control strategy, e.g., via driven cooling rollers, driven conveyor rollers, and/or driven carrier rollers, as further printing press modules.

The parameters and time elements may be adapted using fuzzy techniques, model-based techniques, e.g., model tracking control, observer techniques, or Kalman techniques.

The method may be used, e.g., with gravure presses, in-line flexo printing presses, commercial printing presses, or newspaper roll printing presses. A web press may be designed as a shaftless printing press with individual motors and/or drives, individual drives on the individual printing units, or web transport rollers or cooling rollers. An impression cylinder may be driven via a single drive in each printing unit. The impression cylinder, e.g., pressure roller, may be driven individually, or indirectly, so that it may therefore be driven directly via the impression cylinder.

In a further variant, a change is carried out inside the printing press. This means, e.g., that the first colors are adjusted relative to a color/precursor color, since, in a gravure press, light colors are often printed first, and contrast problems may occur with the sensors. In this variant, adjustment is therefore carried out relative to a key color.

Typically, dynamic and static couplings may be combined with each other by changing factors, in order to compensate for influences due to machine or material behavior, e.g., friction or acceleration, and in particular for the time elements.

Further advantages and embodiments of the present invention result from the description and the attached drawing.

It is understood that the features mentioned above and to be described below may be used not only in the combination described, but also in other combinations or alone without leaving the framework of the present invention.

### Exemplary embodiments

### DESCRIPTION OF THE FIGURES

The present invention is depicted schematically with reference to exemplary embodiments in the drawing, and it is described in detail below with reference to the drawing.

FIG. 1 shows, in a schematic depiction, an example of a current static downstream control strategy that is applied when there is a register deviation at a printing unit.

FIG. 2 shows an example of register error behavior that occurs when a static downstream control strategy known from the related art is applied.

FIG. 3 shows, in a schematic depiction, a detailed view of an inventive printing press in a first embodiment of the inventive method when a downstream control strategy with dynamic decoupling is applied.

FIG. 4 shows, in a schematic depiction, the details—presented in FIG. 3—of the printing press when a second embodiment of the inventive method is carried out, in which an upstream control strategy with dynamic decoupling for a key color and a color/precursor color is provided.

FIG. 5 shows a diagram of a decoupling when an impression cylinder is adjusted for a color/precursor color control within the framework of a third embodiment of the inventive method.

FIG. 6 shows a diagram of a decoupling when an impression cylinder is adjusted for a key color control within the framework of a fourth embodiment of the inventive method.

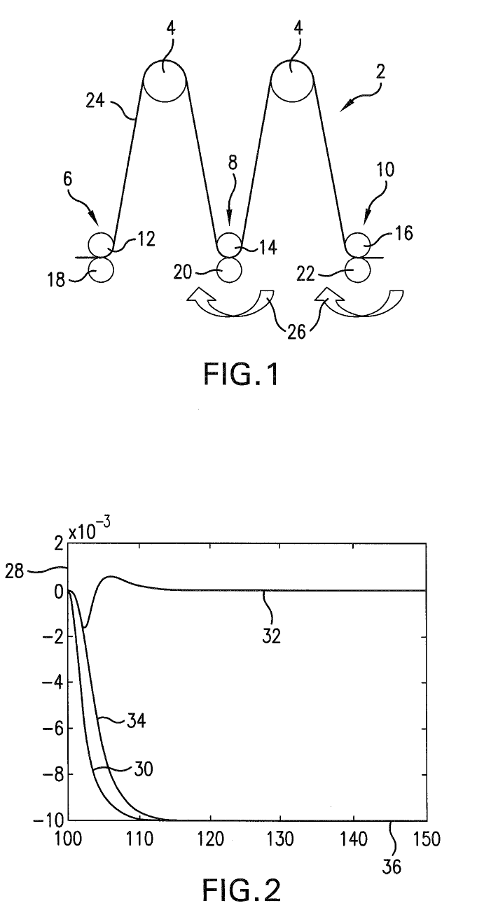

FIG. 1 shows, in a schematic depiction, a detailed view of a printing press 2. Printing press 2 includes carrier and/or cooling rollers 4 and three printing units 6, 8, 10, with each printing unit 6, 8, 10 including a pressure roller 12, 14, 16 and an impression cylinder 18, 20, 22. When printing press 2 is operated, it is provided that a material web 24 to be printed on moves between pressure rollers 12, 14, 16 and impression cylinders 18, 20, 22 of printing units 6, 8, 10, and travels over carrier rollers 4.

With the downstream strategy provided per the related art, with printing press 2, a printing unit 8 at which a register deviation occurs is adjusted and, synchronous therewith, all downstream printing units 10 (only one of which is shown) are also adjusted.

The result is that, when the adjustment is carried out, only the register between first and second printing unit 6, 8 is changed. The goal should be—depending on the control strategy selected, i.e., whether it is a color/precursor color or a key color—for the registers between second and third printing unit 8, 10 or between first and third printing unit 6, 10 to remain unchanged.

In this procedure, however, the adjustment of an impression cylinder 18, 20, 22 is not decoupled. Other registers are therefore affected by the adjustment, and a register controller of printing press 2 must be active in order to realize angle corrections 26.

FIG. 2 shows a diagram with an axis 28 for a register error for plots 30, 32, 34 of individual registers y (6, 8), y (8, 10), y (6, 10)—which are plotted on a time axis 36—according to the example shown in FIG. 1. When a synchronous adjustment of second and third printing unit 8, 10 is carried out, a first register y(6, 8) changes in the desired manner. Neither of the other two registers y(6, 10) and y(8, 10) remains unchanged, however. In the stationary state, second register y (8, 10) returns to the home position, but the dynamic control error of the register controller must be corrected in order to avoid waste. Since the third register y(8, 10) also changes, this control strategy is not suitable for key color control, either.

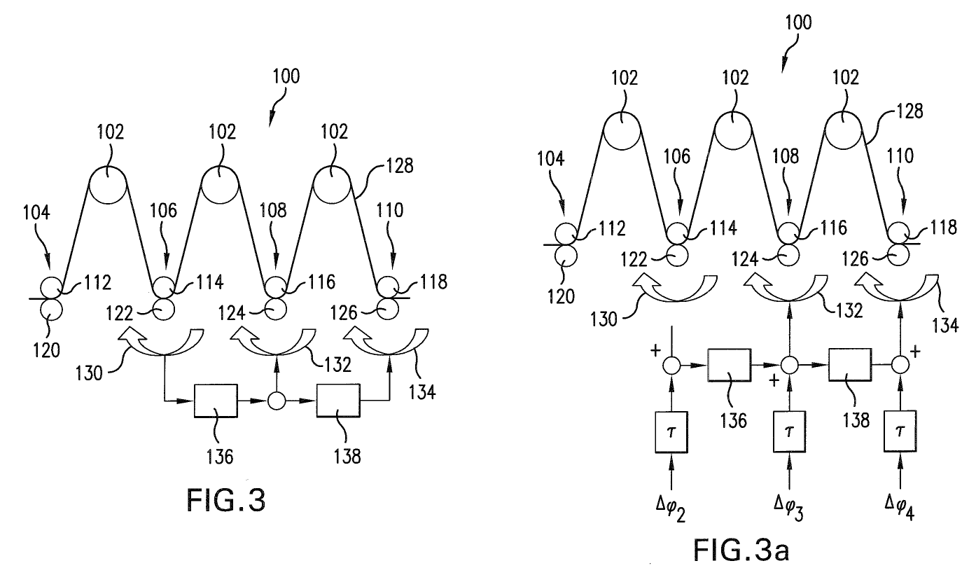

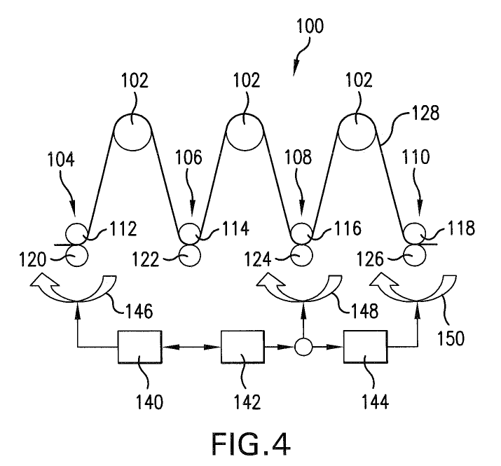

FIGS. 3 and 4 each show a detailed view of an embodiment of an inventive printing press 100. Printing press 100 includes carrier and guide rollers 102, a first printing unit 104, a second printing unit 106, a third printing unit 108, and a fourth printing unit 110. Each of these printing units 104, 106, 108, 110 includes a pressure roller 112, 114, 116, 118 and an impression cylinder 120, 122, 124, 126. A material web 128 to be printed on by printing press 100 moves during a printing process between pressure rollers 112, 114, 116, 118 and impression cylinders 120, 122, 124, 126 of printing units 104, 106, 108, 110, and it travels over guide and/or cooling rollers 102.

A downstream control strategy with dynamic decoupling is described in FIG. 3. In this case, first printing unit 106 with the register deviation is adjusted. All subsequent printing press modules—which are printing units 108, 110 in this case—are adjusted dynamically using correction values 132, 134. These are values 132, 134 for angle corrections that are derived from the correction value 130 used to adjust first printing unit 106. They are derived with consideration for dynamic time elements 136, 138 with different amplitudes and a different dynamic response. In this example, with the downstream control strategy, the dynamic time elements 136, 138 that are provided are proportional elements P, PT1, PT2, PTn, differential elements DT1, DTn, Tt, and integral elements IT1, ITn, each with different factors and time constants. As an option and depending on the application, it is possible—as shown in FIG. 3a—to take further correction values into account, i.e., delta phi 2 through delta phi 4, with or without further dynamic time elements (as described above). It is not absolutely necessary that time elements be used in every path.

FIG. 4 shows a schematic depiction of an embodiment of an upstream control strategy with dynamic decoupling, which may be carried out for a key color or a color/precursor color. Dynamic time elements 140, 142, 144—each with different factors and time constants—are also provided here.

A second printing unit 106 at which the register deviation occurs is not adjusted in this case. Upstream, first printing unit 104 with a draw-in mechanism is adjusted simultaneously by a correction value 146 using control commands, which are time elements 140 that are provided with a factor in general, and/or which are dynamic. In this case they are inverse control commands. Downstream printing units 108, 110, which include drawing rollers, are adjusted with correction values 148, 150 with the same or different decoupling. Correction values 148, 150 are values for angle corrections in this case. This takes place, e.g., with a different amplitude, different factors and time constants, and/or a different dynamic response for the time elements 140, 142, 144, to be taken into account, e.g., P, PT1, PT2, . . . , PTn, DT1, DTn, Tt, IT1, . . . , ITn. Different decoupling elements are combined in this case.

In addition thereto, or as an alternative, a key color control may be carried out. Adjustment is carried out, e.g., relative to a fixedly defined color. Decoupling may be carried out with the upstream control strategy, according to which printing unit 106 at which the register deviation occurs is not adjusted. Upstream printing unit 104 is adjusted simultaneously with the draw-in mechanism using control commands, which are provided with factors, and which are inverse control commands in this case. Downstream printing units 108, 110 with the drawing rollers may be adjusted with identical or different decoupling. This may be carried out, e.g., with a different amplitude and/or different dynamic response of dynamic time elements 140, 142, 144, e.g., P, PT1, PT2, PTn, DT1, DTn, Tt, IT1 ITn. Different decoupling elements may be combined with dynamic time elements 140, 142, 144.

The upstream key color control differs in terms of time elements 140, 142, 144 and their combination of upstream color/precursor color control.

As an option and depending on the application, it is also possible in this case—as shown in FIG. 3a—to take further correction values into account, i.e., delta phi 2 through delta phi 4, with or without further dynamic time elements (as described above). It is not absolutely necessary that time elements be used in every path. For example, a value delta phi 3 could be added to printing unit 108. It would then have to be forwarded to printing unit 104 and 106 using dynamic time elements, and to printing unit 110, in order to also decouple them (not shown). This example must be adapted accordingly to other embodiments, so that all printing units may be influenced by the additional value.

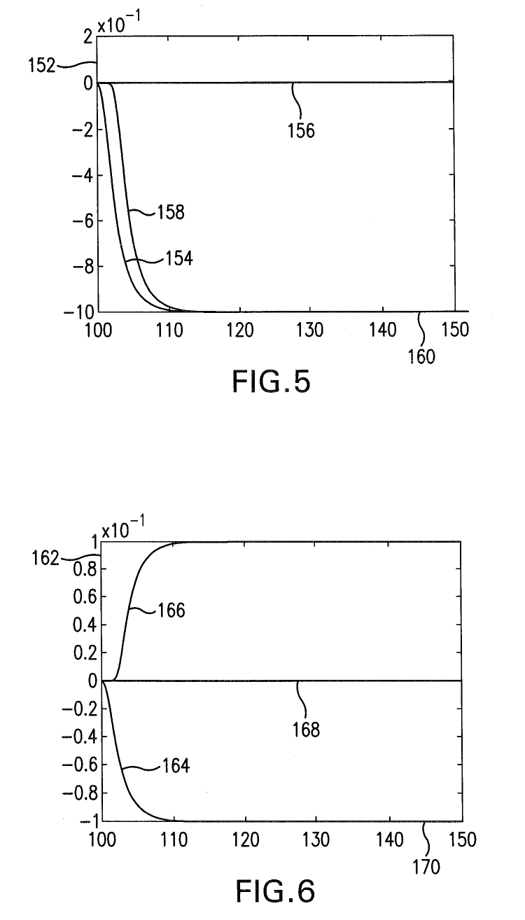

FIG. 5 shows a diagram with an axis for a register error for plots 154, 156, 158 of individual registers y (104, 106), y (106, 108), y (104, 108)—which are plotted on a time axis 160—when decoupling is carried out in an adjustment for color/precursor color control, e.g., according to the example shown in FIG. 4.

As a result of the dynamic coupling of the impression cylinders, e.g., the controlled system is linearized. In addition, the effect of register adjustments on the subsequent registers that occurs when a color/precursor color control is carried out may therefore be fully decoupled. This means that only register y (i−1, i) changes when the register deviation occurs at printing unit i. All other registers that are considered in this control, i.e., y(1, 2), . . . , y((i−2), (i−1)), y(i, (i+1)), . . . , remain decoupled from this adjustment. This means less waste and a linearization of the printing process.

FIG. 6 shows a diagram with an axis 162 for a register error for plots 164, 166, 168 of individual registers y (104, 106), y (106, 108), y (104, 108)—which are plotted on a time axis 170—when decoupling is carried out in an adjustment for a key color control according to the example shown in FIG. 4.

As shown in the diagram in FIG. 6, the effect of register adjustments on the subsequent registers is fully decoupled when a key color control is carried out. This means that only register y (s, i) changes when the register deviation occurs at printing unit i (“s” stands for the particular key color). All other registers that are considered in this control, i.e., y(s, 2), . . . , y(s, (i−1)), y(s, (i+1)), . . . , remain decoupled from this adjustment. This means less waste and a linearization of the printing process.

The effects of register corrections may therefore be fully decoupled, with consideration for the time dependencies. Waste may therefore be reduced or even prevented when compensation processes are carried out.

### LIST OF REFERENCE NUMERALS

2 Printing press
4 Carrier roller and/or cooling roller
6, 8, 10 Printing units
12, 14, 16 Pressure roller
18, 20, 22 Impression cylinder
24 Material web
26 Angle correction
28 Axis
30, 32, 34 Plots
36 Time axis
100 Printing press
102 Carrier roller and/or cooling roller
104, 106, 108, 110 Printing units
112, 114, 116, 118 Pressure roller
120, 122, 124, 126 Impression cylinder
128 Material web
130, 132, 134 Correction values
136, 138, 140 Time elements
142, 144
146, 148, 150 Correction values
152 Axis
154, 156, 158 Plots
160 Time axis
162 Axis
164, 166, 168 Plots
170 Time axis

What is claimed is:

1. A method for dynamically adjusting at least one printing press module of a printing press (100) for correcting a first register,
wherein,
to perform the dynamic adjustment, only the first register is changed, and further registers are decoupled from the dynamic adjustment via a first correction value (130) for the at least one printing press module or via coupling the first correction value (130) with further correction values (132, 134, 146, 148, 150) for further printing press modules with consideration for dynamic time elements (136, 138, 140, 142, 144).

2. The method as recited in claim 1, with which printing press modules are adjusted with different amplitudes and/or a different dynamic response.

3. The method as recited in claim 1, with which all registers except for the first register are decoupled, using an upstream control strategy.

4. The method as recited in claim 1, with which registers that are located downstream of the first register are decoupled, using a downstream control strategy.

5. The method as recited in claim 1, with which a key color control, in particular an upstream key color control, is carried out.

6. The method as recited in claim 1, with which a color/precursor color control is carried out.

7. The method as recited in claim 1, with which the correction values (130, 132, 134, 146, 148, 150) are provided with consideration for a correction value (130, 132, 134, 146, 148, 150) of the at least a first printing press module.

8. The method as recited in claim 1, with which the dynamic time elements (136, 138, 140, 142, 144) are adjusted.

9. The method as recited in claim 1, with which several time elements (136, 138, 140, 142, 144) are combined with each other.

10. The method as recited in claim 1, with which dynamic time elements (136, 138, 140, 142, 144) of the printing press modules are taken into account.

11. The method as recited in claim 1, with which a dynamic response of the dynamic time elements (136, 138, 140, 142, 144) is taken into account.

12. A printing press designed to perform a dynamic adjustment of at least one printing press module, for correcting a first register,
wherein,
to perform a dynamic adjustment, the printing press (100) only changes the first register, and further registers are decoupled from the dynamic adjustment via a first correction value (130) for the at least one printing press module, or by coupling the first correction value (130) with further correction values (132, 134, 146, 148, 150) for further printing press modules, with consideration for dynamic time elements (136, 138, 140, 142, 144).

13. The printing press as recited in claim 12, with which the at least one printing press module is designed as a printing unit (106, 108, 110).

14. A computer program with program code means, to carry out all steps of a method as recited in claim 1 when the computer program is run on a computer or a related arithmetic unit.

15. A computer program product with program code means stored on a computer-readable data storage device, to carry out all steps of a method as recited in claim 1 when the computer program is run on a computer or a related arithmetic unit.
